(19) United States
(12) Patent Application Publication
(10) Pub. No.: US 2005/0212504 A1
(43) Pub. Date: Sep. 29, 2005

(54) System and method for cable localization

(76) Inventors: Dan Revital, Jerusalem (IL); Edmond Shapiro, Boulder, CO (US); Andrew Valentine, Hampshire (GB)

Correspondence Address: WELSH & KATZ, LTD, 120 S RIVERSIDE PLAZA, 22ND FLOOR, CHICAGO, IL, 60606, US

(21) Appl. No.: 10/895,457

(22) Filed: Mar. 24, 2004

(51) Int. Cl. G01R 13/04; G01R 17/06

(52) U.S. Cl. 324/100

(57) ABSTRACT

A method and system for determining cable network topology for a plurality of set-top boxes connected to the cable network, the method comprising using existing information transmitted within the cable network for a non-location purpose to determine an absolute physical location of at least one set-top box within the topology. Related methods and apparatus are also described.

### FIELD OF THE INVENTION

The present invention relates to a system and a method for cable localization.

### BACKGROUND OF THE INVENTION

Many different types of content are currently distributed to users over a cable television system, in which a set-top box for a television set is typically physically connected to a cable network. The cable network connects these boxes to central head-ends, which transmit the content itself. Although this system requires that the cable be laid, usually underground, it is nonetheless a cost effective and efficient method to distribute content. In addition, such cable networks are now also used for broadband connections, which enable households to receive high bandwidth Internet connections. Such high bandwidth connections are becoming increasingly popular with consumers, thereby reinforcing the popularity of cable networks.

However, in order for cable networks to operate efficiently, the physical location of the set-top box, relative to the appropriate cable head-end, must be determined. Such localization is important for new services and applications, such as targeted advertisements for example, which are preferably transmitted only to a particular area or location. Unlike the IP addressing system, which is used for the Internet for example, the topology of current cable networks does not include routing techniques or specifically assigned addresses.

Instead, cable networks use transport streams from the cable head-end through the network to the set-top boxes. Different transport streams may be used for transmission from the same head end to set-top boxes at different physical locations, such that the transport streams themselves do not represent a permanent addressing mechanism, again unlike the IP system. A typical physical implementation of a cable network will include an HFC (hybrid fiber coaxial) connection from the cable head-end to a node, which is like a substation. This type of cabling is more expensive than older coaxial cable and may transmit many different frequencies (typically 500-2000). From the node to the set-top boxes, often older coaxial cables are used, which cables are more limited in number of frequencies (typically about 120). Each frequency represents a transport stream; however, all frequencies which are transmitted on the cable connection to the set-top box are also transmitted to each connected set-top box, because of the lack of addressing in the system.

One potential solution is to use a smart card for each set-top box to determine the location of the box within the cable network. This smart card would be sent to each subscriber at a particular postal address; since the postal address would be known, the smart card could transmit information to the cable head-end about the physical location of the set-top box. However, such a system would clearly be open to fraud and abuse, at least with regard to this aspect of the system.

Furthermore, the location of the node or substation for the cable network may differ even between neighboring houses. The granularity requirement for the cable network is quite high, much higher than for satellite television transmission. For example, the footprint of the satellite may cover an entire country, continent, or other large area. By contrast, cable networks require the precise location of small groups of set-top boxes (physical locations) to be determined, on the order of about 2000 set-top boxes or less. Therefore, an external mechanism to determine the absolute physical location of set-top boxes is required.

Another attempted solution to this problem required a GPS (global positioning system) device to be attached to each set-top box. The GPS device could then determine the physical location of the set-top box. For example, U.S. Pat. No. 6,108,365 to Philip A. Rubin and Associates, Inc. describes a system in which the GPS determines the location of the set-top box, which also receives location-specific signals from the central control, based upon the expected location of the set-top box. U.S. Pat. No. 6,009,116 also to Philip A. Rubin and Associates, Inc. describes a similar system. However, this solution is clearly expensive and impractical.

Yet another attempted solution to this problem is to embed information in the transport stream itself. For example, some VOD (video on demand) vendors have a solution for implementing VOD over cable networks, which involves storage of proprietary information in the storage location used by the transport stream identifier in a normal broadcast in order to be able to identify the specific set top box that is to receive the VOD content; however the inclusion of this information may lead to ambiguity because more than one transport stream might have the same identifier. Therefore, this solution is clearly not desirable.

Important reasons for being able to determine the location of a set-top box within a cable network system include but are not limited to the requirement for different channel assignments in some areas. For historical and regulatory reasons, particularly in crowded urban or suburban areas, a particular channel assignment must be maintained. For example, the weather reporting could be assigned to channel 1, while sports are assigned to channel 2. Many of these fixed channel assignments arose from their implementation for analog broadcast transmissions, before the advent of digital cable. In order to retain these assignments, a mapping table is used by the set-top box. Therefore, different tables must be sent to set-top boxes in different neighborhoods. Again, knowledge of the absolute physical location of the set-top box within the cable network is required.

Another example is the requirement in some areas for a “blackout” of particular programming, even if neighboring areas are allowed to receive it. For example, games or matches in sports are often restricted by physical area; if a sports team fails to sell enough tickets to a “home” game in its city, the team may have an agreement with a television broadcaster to not transmit the game to local set-top boxes. However, since many programs are broadcast nationally through cable television, a mechanism is required to prevent a set-top box in the city of the sports team from receiving the game. Such a “blackout” can only be implemented if the absolute physical location of the set-top box within the cable network system is known.

Thus, clearly a solution to the problem of being able to determine the location of a set-top box within a cable network system is required. However, all of the currently proposed solutions are also clearly unsatisfactory.

### SUMMARY OF THE INVENTION

None of the background art solutions teaches or suggests a mechanism to determine the absolute physical location of a set-top box without requiring additional hardware. In addition, none of the background art solutions teaches or suggests a solution which is low cost, efficient and also enables the location to be determined through a mechanism that is at least partially external to the set-top box itself.

Therefore, there is an unmet need for, and it would be highly useful to have, a system and a method for determining the absolute physical location of a set-top box within a cable network system. By “absolute physical location” it is meant the physical (rather than logical) location of the set-top box according to a certain degree of granularity (precision). The method and system of the present invention, in certain preferred embodiments thereof, meet this need by determining the absolute physical location of a set-top box within a cable network system.

The method and system of the present invention, in certain preferred embodiments thereof, operate to determine the relative cable network topology, with regard to the location of individual set-top boxes within the topology, at least partially according to existing information that is already passed within the system, for example through OOB (out-of-band) messages, which are not sent with the transmitted content. The information is external to the set-top boxes, which do not need to be preconfigured and/or configured with an internal or additional device (such as a smartcard for example). Rather, the information is passed during routine transmissions between the set-top box and the cable head-end. Thus, unlike other background art methods described previously, the present invention, in certain preferred embodiments thereof, does not require special information to be inserted into transport streams between the set-top box and the cable head-end. The present invention, in certain preferred embodiments thereof, is preferably implemented with a system which is capable of two-way transmissions between the set-top box and the cable head-end and/or another network component under at least some circumstances.

According to a preferred embodiment, the present invention uses the upstream channel identifier assignment mechanism to identify set-top boxes by location, optionally and more preferably combined with a mapping mechanism which optionally and most preferably derives information from the ability of a set-top box to identify an assigned DOCSIS upstream channel identifier, and to retrieve the LEP (localization entry-points) mapped to this upstream channel identifier. This LEP is then used for determining further localization dependent identifiers and assignments. Such an upstream channel identifier is used for cable networks featuring two-way transmission, in which each set-top box also preferably features an embedded cable modem.

Alternatively, mapping of the set-top box may optionally be performed by using the cable-headend assigned out-of-band downstream channel to the set-top box. It should be noted that generally, inband and out of band channels may be distinguished as follows, across different types of technologies. Inband refers to the primary use of a standard or type of technology for communication, while out of band refers to any additional use, for example for sending control signals and/or other messages. Transport streams are inband, while the downstream channel and upstream channel are out of band for the purposes of the present application. This out of band channel or channels is then used to determine other types of location information about the set-top box.

For example, the head-end may broadcast a plurality of LEPs. A newly connected set-top box would receive a particular LEP, by virtue of the set-top box's location within the network. Preferably each LEP would be mapped to a particular node and/or other subset of the cable network system. The cable head-end could then optionally broadcast a table, containing mapping information, for which the LEP would be the key. Preferably the LEP is mapped one-to-one with the upstream channel identifier in a two-way system. The set-top box would therefore be self-located within the system, although it would not be able to verify this location by a return message to the cable head-end without the optional embodiment of two-way transmissions. The LEP could also be used for other types of self-location functions by the set-top box.

The mapping (and hence localization of the set-top box) enables such services as targeted advertisements to be provided, since the advertisement server is able to use the mapping information to determine which set-top box(es) should receive a particular advertisement. For example, an advertisement would optionally and preferably be targeted to a particular neighborhood (group of set-top boxes), as the physical location or area which is to receive the advertisement could preferably be selected according to the mapping information.

The present invention, in certain preferred embodiments thereof, has the benefit of being strongly resistant to cheating or unauthorized manipulation, because an incorrect upstream channel identifier and/or using an incorrect out-of-band downstream channel would prevent the set-top box from operating properly.

The system and method of the present invention, in certain preferred embodiments thereof, may optionally be used with any appropriate type of cable network system, as well as with any appropriate type of transmission protocols and/or applications which operate over such a system. Various illustrative examples are given herein of the operation of such protocols and applications with regard to the system of NDS Limited (United Kingdom); however, it is understood that these examples are given for the purposes of description only and are not meant to be limiting in any way.

U.S. Pat. Nos. 5,282,249 and 5,481,609, describe effective security mechanisms for the system of NDS Limited with which the present invention, in certain preferred embodiments thereof, may optionally operate and which are hereby incorporated by reference as if fully set forth herein. The disclosed system enables a signal containing media content to be broadcast widely, yet only to be played back or otherwise displayed by authorized users. This signal could contain a television program for example. The signal is scrambled, such that the authorized users are able to descramble the signal and play back or otherwise display the media content only with the proper security device, such as a smart card for example. Thus, widely received media content is still protected from access by unauthorized users.

The scrambled television data streams described in U.S. Pat. Nos. 5,282,249 and 5,481,609 feature both scrambled data representing television signals and coded control messages, also known as ECMs. These ECMs contain, in a coded form, data necessary for generating a control word (CW) which may be used to descramble the scrambled data representing television signals. The disclosed system enables a signal containing media content, such as a television program for example, to be transmitted widely, yet only to be played back or otherwise displayed by authorized users.

Data necessary for generating a control word is known in the background art to take many different forms and may include, in general, at least any of the following: a control word; an encrypted control word packet which is intended to be decrypted before use; and a seed to a generating function such as, for example, a one-way function which generates the control word upon input of the seed.

While U.S. Pat. Nos. 5,282,249 and 5,481,609 describe an analog system, that is, a system in which analog television data streams are broadcast to television sets, it is appreciated that similar ECM methods may also be used for digital television data streams. Generally, the scrambling techniques used for scrambling analog television signals such as, for example, the well-known “cut-and-rotate” technique, are chosen for their particular applicability to analog signals. However, scrambling of digital television signals preferably employs other techniques, which are well-known in the art and which are more appropriate to digital signals. One example of such a technique is the application of the well-known DES algorithm to the digital television signals. Other examples include the well-known triple DES algorithm and the DVB (digital video broadcasting) CSA (common scrambling algorithm).

Methods of transmitting a scrambled digital signal, including ECMs and EMMs, are described in the MPEG-2 standard, ISO/IEC 13818-1, 15 Apr. 1996 and subsequent editions.

Another attempted solution to the problem of content protection is described in published European Patent Application No. EP 0858184 and corresponding U.S. Pat. No. 6,178,242, which disclose a digital recording protection system and which are hereby incorporated by reference as if fully set forth herein. The disclosed system enables the digital content to be sent in a scrambled format, such that the digital content cannot be read and/or displayed without a key. The key is obtained from a control message, which is only sent to authorized users. Preferably, the key is obtained from coded information contained within the Entitlement Control Message, or ECM, for generating a code word associated with the ECM. Thus, only authorized users are able to correctly read and/or display the digital content.

In addition, the system and method described in European Patent Application No. EP 0858184 enable the authorized user to record and playback or otherwise display the digital content, while preventing the user from producing and distributing multiple playable copies of the digital content to other, non-authorized users. Therefore, the authorized user is able to fully use and enjoy the digital content, while the content itself is still protected from unauthorized use.

The present invention, in certain preferred embodiments thereof, may optionally operate with the previously described background art systems as follows. An EMM (entitlement message) may need to be sent to subscribers, for example for targeted advertisement applications, in order for the set-top box to be able to use the correct ECM for decoding the content. A general broadcast of all EMM's to all set-top boxes would require too much bandwidth. It is therefore desirable to select EMM's for broadcast according to the cable topology. For example, EMM's may be transmitted according to the node alone or according to a group of nodes, or according to the hub. All of these components represent portions of the cable network, such that the EMM's only need to be sent to the relevant portion of the set-top boxes in the network and not to all set-top boxes. Thus, the ability of the present invention to determine the physical location of the set-top box may optionally be used to increase the efficiency of transmitting EMM's and/or other messages to the set-top boxes.

The disclosures of all references mentioned above and throughout the present specification are hereby incorporated herein by reference.

For preferred embodiments of the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++, Java and Assembly.

In addition, preferred embodiments of the present invention could be implemented as software, firmware or hardware, or as a combination thereof. For any of these implementations, the functional steps performed by the method could be described as a plurality of instructions performed by a data processor. In addition, for the software implementation, the functional steps performed by the method could be described as a plurality of instructions performed by a computer software product.

Hereinafter, “Applied Cryptography” by Bruce Schneier, John Wiley 2nd ed. 1996, is incorporated by reference as if fully set forth herein, for the teachings regarding cryptography and techniques for implementation thereof.

There is thus provided in accordance with a preferred embodiment of the present invention a method for determining cable network topology for a plurality of set-top boxes connected to the cable network, including using existing information transmitted within the cable network for a non-location purpose to determine an absolute physical location of at least one set-top box within the topology.

Further in accordance with a preferred embodiment of the present invention the cable network features two-way transmissions, such that the using the existing information includes listening for an identifier by the at least one set-top box, and transmitting the identifier in an upstream transmission by the at least one set-top box for identifying the at least one set-top box.

Still further in accordance with a preferred embodiment of the present invention the listening for the identifier includes receiving mapping information by the at least one set-top box, and listening to at least one transmission frequency selected according to the mapping information.

Additionally in accordance with a preferred embodiment of the present invention the mapping information includes a LEP for analysis of the mapping information.

Moreover in accordance with a preferred embodiment of the present invention the LEP is used as a key for the mapping information.

Further in accordance with a preferred embodiment of the present invention the using the existing information includes transmitting a message on an OOB (out of band) channel.

Still further in accordance with a preferred embodiment of the present invention transmitting an ENM to a portion of the cable network topology according to the LEP.

Additionally in accordance with a preferred embodiment of the present invention transmitting a targeted advertisement to the at least one set-top box according to the at least one LEP.

Moreover in accordance with a preferred embodiment of the present invention receiving a FIPS code according to the LEP, and determining an emergency message according to the FIPS code.

Further in accordance with a preferred embodiment of the present invention associating a transport stream with a region for a user according to the LEP.

Still further in accordance with a preferred embodiment of the present invention assigning a LEP according to a UCID (upstream channel identifier) for at least one set-top box for localizing the at least one set-top box.

Additionally in accordance with a preferred embodiment of the present invention determining at least one location-based or location-sensitive assignment according to the LEP.

Moreover in accordance with a preferred embodiment of the present invention determining at least one location-based or location-sensitive message according to the LEP.

Further in accordance with a preferred embodiment of the present invention providing an advertisement to the at least one set-top box according to the LEP.

Still further in accordance with a preferred embodiment of the present invention the assigning the LEP is performed by a DSG Server, communicating with a DSG Client at the at least one set-top box.

There is also provided in accordance with another preferred embodiment of the present invention a plurality of transmission channels, wherein each set-top box is capable of listening to at least one transmission channel but not to all transmission channels, the system including a cable network component for transmitting data to the transmission channels, wherein the transmitted data differs between at least two of the transmission channels, a map for mapping information concerning a relative location of at least one set-top box within the topology, wherein the map is transmitted to the at least one set-top box and wherein the transmitted data forms a key to the map, such that the at least one set-top box is capable of determining the relative location within the topology according to the map and the key.

Further in accordance with a preferred embodiment of the present invention the cable network features two-way transmissions between the cable network component and the plurality of set-top boxes, such that the transmission channels including an upstream channel and a downstream channel, the upstream channel featuring an upstream channel identifier, and wherein the at least one set-top box determines a capability of communicating on the upstream channel according to the upstream channel identifier, the at least one set-top box transmitting the upstream channel identifier to the cable network component and the upstream channel identifier forming a portion of the mapping information for the map.

Still further in accordance with a preferred embodiment of the present invention the transmitted data is transmitted for a purpose other than determining the relative location.

Additionally in accordance with a preferred embodiment of the present invention the transmitted data includes a LEP (localization entry point).

There is also provided in accordance with a still another preferred embodiment of the present invention a plurality of two-way transmission channels, each transmission channel featuring an upstream channel having an upstream identifier and a downstream channel, wherein each set-top box is capable of listening to at least one transmission channel but not to all transmission channels, the system including a cable network component for receiving a communication from at least one set-top box, wherein the at least one set-top box identifies the upstream identifier of the upstream channel being received by the at least one set-top box and transmits the upstream identifier to the cable network component, and a map for mapping information concerning a relative location of the at least one set-top box within the topology according to the upstream identifier, wherein an absolute physical location of each transmission channel within the topology is known.

### BRIEF DESCRIPTION OF THE DRAWINGS

The invention is herein described, by way of example only, with reference to the accompanying drawings, wherein:

FIG. 1 is a schematic block diagram of an exemplary system according to the present invention;

FIG. 2 shows a schematic block diagram of an exemplary hierarchy according to the present invention; and

FIG. 3 shows an exemplary method for determining the physical location of the set-top box with two-way transmissions within the cable system, according to transmission of a LEP.

### DESCRIPTION OF THE PREFERRED EMBODIMENTS

The present invention, in preferred embodiments thereof, is of a method and system for determining the physical location of individual set-top boxes, preferably at least partially by using existing information that is already passed within the system. The information is preferably external to the set-top boxes, which do not need to be preconfigured and/or configured with an internal or additional device (such as a smartcard for example). Rather, the information is passed during routine transmissions between the set-top box and the cable head-end. Thus, unlike other background art methods described previously, the present invention, in preferred embodiments thereof, does not require special information to be inserted into the content transport streams between the set-top box and the cable head-end, although OOB (out-of-band) message channels may optionally be used for message transmission. The present invention, in preferred embodiments thereof, is preferably implemented with a system which is capable of two-way transmissions between the set-top box and the cable head-end and/or another network component under at least some circumstances.

According to a preferred embodiment, the present invention uses the upstream channel identifier assignment mechanism to identify set-top boxes by location. Such an upstream channel identifier is used for cable networks featuring two-way transmission, in which each set-top box optionally and preferably also features an embedded cable modem.

Set-top boxes which operate on a cable network featuring two-way transmissions preferably receive an upstream channel identifier from the cable head-end upon registration, which occurs when first connecting to the network and/or rebooting the set-top box; this mechanism is used for example in networks implemented according to the DOCSIS standard (see for example SCTE 22-1, SCTE 23-1, or SCTE 79-1, from the SCTE (Society of Telecommunications Engineers)). The location of the head-end is known; furthermore, the head-end controls a known physical area, which corresponds well with the limits of the required area within which the set-top box location needs to be determined. A group of set-top boxes, typically (but not necessarily) corresponding to a few hundred boxes in the same physical area, have the same upstream channel identifiers when the network is implemented according to the DOCSIS standard. Preferably, this group is associated with a particular node; typically (although not necessarily) a head-end controls a plurality of nodes, directly or indirectly (for example through a hub as described in greater detail below). However, it should be understood that the present invention, in preferred embodiments thereof, is also operative when the identifier is sent to a single set-top box or a small group of set-top boxes, as long as the set-top boxes sharing the upstream channel identifier are located within a physical area which is sufficiently small for the purposes of the present invention, according the requirements for localization which in turn depend upon the use of the present invention.

The cable head-end preferably configures the list of upstream channel identifiers that are used by DOCSIS in advance, for transmission of localization maps based on these upstream channel identifiers by the DSG Server. The DSG Server is responsible for generating the DSG Tunnel contents that are sent to the set-top box over a DOCSIS downstream channel. The present invention, in preferred embodiments thereof, is preferably implemented such that necessary information (such as various region identifiers) for the set-top boxes is also placed in the DSG Server.

A map is then preferably determined for mapping between these pre-defined upstream channel identifiers and the physical location of the set-top boxes. Such a map (containing mapping information) is preferably performed in advance, by populating data into the DSG Server database tables.

The mapping information, or at least a portion thereof, is sent to the set-top box through the DSG standard messaging function, such as by using DCDs (Downstream Channel Descriptors) for example.

According to preferred embodiments of the present invention, upon initial registration of and/or restarting the set-top box, the set-top box locates an out of band downstream channel. The set-top box is assigned an upstream channel identifier (UCID) by the CMTS for example, or some other type of server (depending upon the particular implementation of the present invention) which is preferably located at the cable head-end and/or hub. This process could also be implemented according to reference standards SCTE 55-1 or SCTE 55-2 for example, or according to DHCP or any other appropriate out of band method, as can be appreciated by one of skill in the art.

More preferably, each UCID is predetermined to be relevant to a particular physical location as previously described.

Next the DSG Server sends the LEP keyed by the UCID to the set-top box. The LEP is a logical location rather than a physical location within the cable network. For a two-way cable network transmission system, a unique LEP is preferably identified with each upstream channel, such that the minimum size of any type of region (see below for examples of different types of regions) is equal to the physical area and also the number of set-top boxes serviced by a single upstream channel. The set-top box receives the LEP. The DSG Server sends location dependent information and assignments keyed by the LEP to the set-top box.

Mapping between the upstream channel identifier and the LEP enables the absolute physical location of the set-top box to be determined and mapped. The cable head-end sends mapping information to every set-top box, preferably as a multicast of all sets of information for all possible upstream channel identifiers that could be used in the physical area served by the head-end. The set-top box then preferably accepts the mapping information according to the upstream channel identifiers and/or according to the LEP. The LEP can optionally and preferably be used as a key for the assignment of many other location-dependent identifiers, optionally and more preferably for the provision of such services as targeted advertising as previously described.

Other applications of preferred embodiments of the system and method of the present invention, which require the determination of the absolute physical location of the set-top box include but are not limited to, determination of the region for “black-out” purposes; determination of time zone; and determination of location for FIPS codes (for example for DEAS (digital emergency alert system), FIPS PUB 6-4 in the FCC decision coded as “47 CFR FCC Part 11”). As previously described, “black-out” regions occur when a content provider (and/or other regulatory authority) has determined that certain content should not be provided to certain regions, for example when a sporting event is being shown at a particular city or other region, in which case the broadcast is often blocked for that city or region.

With regard to time zone, countries such as the USA contain multiple time zones and the region being served by the head-end may span more than one time zone. It is therefore necessary for the set-top box to be configured with the correct UTC (time zone) offset for the time zone in which the set-top box is located.

FIPS codes are used for broadcasting messages in case of (national or regional) emergencies, for example for the DEAS (digital emergency alert system), for which the FIPS codes are according to FIPS PUB 6-4 in the FCC decision coded as “47 CFR FCC Part 11”. In the case of emergency alerts, optionally and preferably the set-top box filters the location information (FIPS code) within the alert so that it may discard alert messages that are not relevant to the geographical location of the set-top box. In order to provide such filtering, the set-top box is required to be configured with the FIPS code for its geographical region. For more information on FIPS codes see www.itl.nist.gov/fipspubs/fip6-4.htm and also FIPS PUB 6-4 in the FCC decision coded as “47 CFR FCC Part 11”, hereby also incorporated by reference as if fully set forth herein.

Another optional but preferred embodiment of the present invention is for EMM segregation, such that bandwidth is not wasted by transmitting EMMs to all portions of the cable network topology, but only to those portions that are relevant.

The principles and operation of preferred embodiments of the present invention may be better understood with reference to the drawings and the accompanying description, which are provided for the purposes of explanation only and without intending to be limiting in any way.

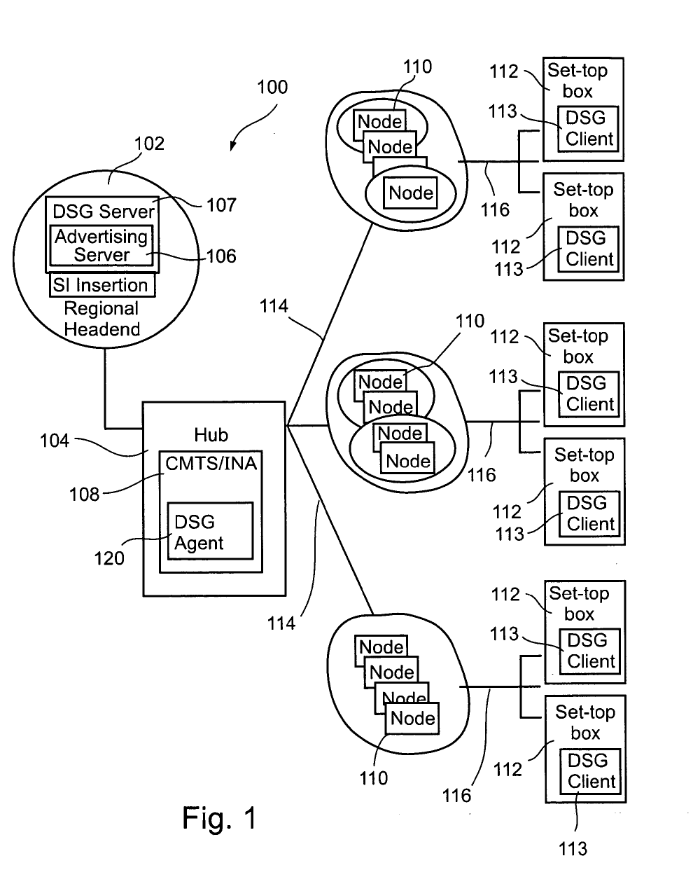

Referring now to the drawings, FIG. 1 is a schematic block diagram of an illustrative system according to the present invention. Although the operation of the system is described with regard to television program content, it is understood that this is for the purposes of illustration only and is without any intention of being limiting in any way.

As shown, a system 100 according to a preferred embodiment of the present invention for a cable network features a cable head-end 102, shown as a regional head-end. Head-end 102 controls and manages content transmission over a geographical region, which typically (although not necessarily) extends to a few thousand cable connections. Head-end 102 optionally and preferably features a DSG Server 107 according to this exemplary, non-limiting implementation of the present invention, although as previously described, the present invention could optionally and alternatively be implemented according to any suitable out of band method, as can be appreciated by one of skill in the art. Head-end 102, and preferably DSG Server 107 within head-end 102, optionally and preferably features a targeted advertising server 106.

Head-end 102 is connected to a hub 104, which preferably includes a CMTS 108 as shown. Although only one hub 104 is shown, head-end 102 may optionally be connected to a plurality of hubs 104 (not shown). Hub 104 in turn is connected to a plurality of nodes 110, of which a number are shown for the purposes of illustration and without any intention of being limiting.

Each node 110 is connected to a plurality of set-top boxes 112, which are typically (although not necessarily) about a few hundred in number. Each node 110 serves a much more limited geographical area than each hub 104, which in turn serves a more limited geographical area than each head-end 102.

Hub 104 optionally communicates with each node 110 through a high bandwidth fiber link 114, which is capable of carrying a high number of different frequencies of transport streams. Typically (although not necessarily), each node 110 in turn communicates with set-top boxes 112 through a lower bandwidth cable connection 116, which may for example be coaxial cable. Therefore, each node 110 optionally communicates to set-top boxes 112 with a lower number of frequencies for transport streams than are available to hub 104. Of course, these are all non-limiting, illustrative examples of the physical layer.

System 100 is preferably implemented according to a standard, such as the DOCSIS cable standard for example, which enables two-way transmissions under at least certain circumstances, for example between set-top box 112 and a CMTS 108, which normally resides in hub 104 but may optionally reside in head-end 102. Such transmissions pass through node 110, which then relays them to hub 104.

The present invention, in preferred embodiments thereof, enables the absolute physical location of each set-top box 112 within system 100 to be determined, without any additional device being added to set-top box 112, according to information already passed between CMTS 108 and set-top box 112.

The present invention, in preferred embodiments thereof, optionally and preferably operates by using OOB (out-of-band) messages for communication with set-top boxes 112 and head-end 102 and/or hub 104. OOB messages are preferred because in certain markets such as the US, both analog and digital channels are delivered by cable; in-band messages cannot be delivered on analog channels, but only when set-top box 112 is connected to a digital channel. OOB messages perform a number of different functions, including subscriber service authorizations and providing system information for set-top box 112, which are both implemented by sending one-way messages (from head-end 102 and/or hub 104 to set-top box 112). Subscriber service authorizations include EMMs (Entitlement Management Messages), which are used to deliver various authorizations to set-top box 112 (for example and without intending to be limiting, a smart card within set-top box 112, not shown) in order to permit set-top box 112 to receive and access content for which the subscriber is authorized.

Other types of one-way messages include, but are not limited to, channel and frequency maps, digital emergency alert messages (FIPS codes) and software download version tables.

Location-based and/or location-sensitive services, on the other hand, preferably feature two-way messages; indeed, more advanced such services require two-way messages. Accurately determining the physical location of set-top box 112 also is preferably performed by using two-way messages for implementations with system 100 featuring two-way transmissions. Therefore, the implementation of two-way communication, such as for advanced location-based and/or location-sensitive services for example, also enables OOB messages to be used for determining the absolute physical location of set-top box 112.

The present invention, according to a preferred embodiment, optionally and preferably operates by enabling set-top box 112 to connect to system 100 through an upstream channel, identified by an upstream channel identifier within system 100. According to a first preferred implementation with a LEP, system 100 is a two-way transmission system, such that the LEP functions as follows. A unique LEP is identified with each upstream transport channel, such that the minimum size of any type of region (see below for examples of different types of regions) is equal to the physical area and also the number of set-top boxes 112 serviced by a single upstream transport channel.

In order to be able to provide the LEP to a newly connected set-top box 112, preferably a map is prepared which describes the relationships between cable head-end 102, an upstream channel identifier and a LEP for each hub 104. Hub 104 optionally and preferably contains a DSG Agent 120 for interacting with DSG Server 107. The mapping is therefore more preferably performed for each DSG Agent 120, and is also more preferably stored in the MIB (management information database; not shown) associated with each DSG Agent 120.

DSG Server 107 preferably has its own identifier, termed herein the region identifier, which is preferably used to determine regional time zones and other information when performing the mapping functions. Other types of regions which may be important include but are not limited to, billing vendor regions (for example from acquisition of multiple smaller cable vendors by a larger vendor), franchise regions which may be required by regulatory authorities in relation to particular groups of channels and/or channel numbering as previously described, and municipal regions (state and/or county and/or city, or other groupings) which are related to broadcast of emergency messages. Some of these regions may be concurrent with the region of hub 104; others may need to be identified within the topology of system 100 itself.

The map preferably includes a relationship between one upstream channel identifier and one LEP, such that each upstream channel identifier maps to only one LEP, while one LEP optionally maps to many upstream channel identifiers. Of course, a one-to-one mapping between each LEP and each upstream channel identifier may optionally be performed.

At least a portion of the mapping information is then transmitted to each set-top box 112, for example by being sent to the associated cable modem embedded in set-top box 112 (not shown). Hub 104 optionally may send only the portion of the mapping information that is relevant for the particular set-top box 112, or alternatively may send all mapping information.

Optionally, the mapping information is sent over a DSG Tunnel. A DSG Tunnel is an IP datagram stream, originating at DSG Server 107. The DSG Tunnel carries OOB messages to set-top boxes 112 over the downstream DOCSIS channel, and is preferably identified by an Ethernet MAC address which is assigned by the content provider related to cable head-end 102. The present invention, in preferred embodiments thereof, preferably includes the feature that some of the information sent over a DSG Tunnel can be associated with a region identifier.

One optional implementation of such a LEP is for targeted advertising, as an example of a location based and/or location-sensitive service. Each node 110 preferably has an associated node identifier, which needs to be mapped to the group of set-top boxes 112 being served by that node 110. Head-end 102 features targeted advertising server 106 as previously described, which provides targeted advertisements to a subscriber of a particular set-top box 112 according to the physical location of set-top box 112. As previously described, the advertisement(s) may optionally be targeted according to a neighborhood or other physical area in which set-top box 112 is located.

Also as previously described, head-end 104 is capable of communicating with a number of different nodes 110, and needs to be able to identify which node 110 should receive the targeted content (such as targeted advertising). Broadcasting any type of localized content to all nodes 110 is inefficient and wasteful.

When set-top box 112 is first connected, initially set-top box 112 is assigned a UCID by CMTS 108. Then the LEP is retrieved based on UCID to LEP mapping sent by DSG Server 107, and then (concurrently or sequentially) set-top box 112 receives the mapping information between LEP and other localization identifiers. The LEP may optionally be received and processed by a DSG Client 113 as shown.

The present invention, in preferred embodiments thereof, is preferably implemented such that necessary information (such as various region identifiers and upstream channel identifiers) for set-top boxes 112 is also placed at DSG Server 107.

DSG Server 107 then determines at least the upstream channel identifier, and optionally and more preferably determines other information as well, such as other region identifiers as previously described. The information also optionally and preferably includes the location of the OOB configuration table for retrieving mapping information. The information may optionally be selected according to a rule base for example. DSG Server 107 preferably uses the UCID (upstream channel identifier) to select appropriate mapping information. The mapping information is then preferably transmitted to set-top box 112.

This optional implementation, with DSG Server 107, may also optionally be used in combination with the LEP implementation described previously. The process begins as previously described, except that DSG Server 107 now selects the appropriate LEP, according to the location (physical/geographical area) of set-top box 112 and the OOB configuration table. Set-top box 112 then receives the LEP and parses it to use the LEP as an index for the configuration tables, which may be retrieved or alternatively transmitted to set-top box 112.

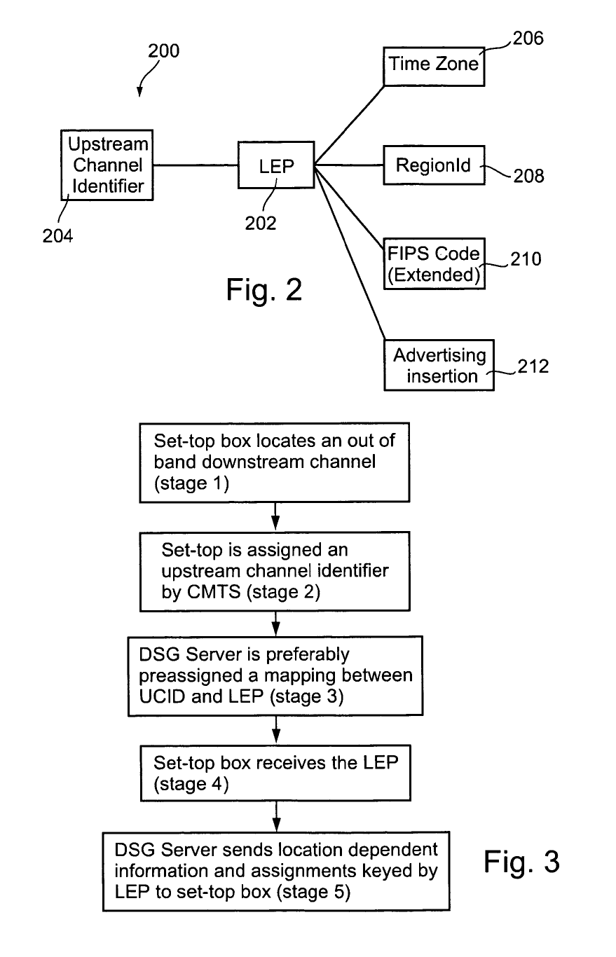

In any case, once the LEP has been broadcast to a set-top box 112, various implementations may optionally use this information to automatically derive additional region information. For example, the LEP key may optionally be used to derive information from a mapping table, related to region specific details such as billing regions, franchise regions, targeted advertising selection and emergency alert municipalities (see also FIG. 2 for a description). The mapping table could optionally be broadcast from cable head-end 108 with information relevant to all LEPs associated with cable head-end 108.

Optionally and preferably, a plurality of nodes 110 may be contained within a group that is smaller than the group associated with hub 104, which smaller group is termed herein a population group. Each population group preferably has an associated population identifier. Population groups may optionally be used for such purposes as transmitting a multicast message, such as for the conditional access system of NDS Limited (United Kingdom).

Also optionally and preferably, an upstream channel is associated with only one time zone, although an upstream channel may optionally be associated with more than one extended FIPS code area (the term “extended” optionally refers to the subdivision of emergency areas by geographic regions in the emergency alert table). An upstream channel is preferably only associated with one region identifier.

FIG. 2 shows a schematic block diagram of these different regions in relation to a LEP (localization entry-point) as described above. A hierarchy 200 includes a LEP 202, from which the set-top box (not shown) automatically locates itself within the cable network system (also not shown). From the correct upstream channel identifier 204, the set-top box preferably first determines LEP 202. Next, the set-top box determines the time zone 206, regional identifier 208 (for the hub, also not shown), the FIPS code 210 (for filtering non-relevant emergency messages), and optionally other types of regions as discussed above (not shown). Another type of information to be selected preferably includes appropriate targeted advertising through advertisement insertion identifier 212 as shown, thereby supporting location-based advertising.

FIG. 3 describes an optional but preferred implementation of a method according to the present invention, for determining the physical location of a set-top box within a cable network featuring two-way transmissions within the cable system, according to transmission of a LEP.

In stage 1, the set-top box locates an out of band downstream channel (for example according to DOCSIS if the cable network is implemented according to this standard, and otherwise according to a method which could easily be determined by one of skill in the art for a particular cable network).

In stage 2, the set-top box is assigned an upstream channel identifier (UCID) by the CMTS (see FIG. 1).

In stage 3, the DSG Server is preferably pre-assigned a mapping between UCID and LEP. It transmits (preferably through a multicast) this mapping as mapping information for example, optionally and more preferably to all set-top boxes which may optionally use this UCID.

In stage 4 the set-top box retrieves the LEP from the mapping information, using its previously assigned UCID as a key. Preferably, the DSG Server sends location dependent information and assignments keyed by LEP to the set-top box (stage 5).

The mapping information may optionally be sent in the form of a table with the following optional, exemplary structure. It should be noted that this structure is given for the purposes of description only, without any intention of being limiting. This table would optionally be multicast by the head end on a well-known port (1314). The repetition period for broadcast may optionally be from about 2 to about 3 minutes for example.

Each section represents the user data area of the datagram, as for the content of a UDP packet. The table may optionally feature multiple sections.

The set-top box preferably only processes a section if the hash value has been authenticated.

Each LEP is optionally identified by a number. Preferably, LEP 0 applies to all set-top boxes and optionally carries default configuration information that applies to the entire set-top box population. This information is then preferably amended when the set-top box parses its specific LEP. Therefore, the information in each section is preferably arranged in ascending order of lep_id (identifiers for the LEP), in order for the LEP information to be parsed in the correct order.

Once the initial localization information has been acquired, the set-top box preferably continues to listen on the port for a change in the version number. If the hash and CRC fields are authenticated, the new localization information is preferably used to re-configure the set-top box.

TABLE 1
Cable Localization Table

| Syntax | No. of Bits | Identifier |
|---|---|---|
| table_id | 8 | Uimsbf |
| section_syntax_indicator | 1 | Bslbf |
| reserved_future_use | 1 | Bslbf |
| Reserved | 2 | Bslbf |
| section_length | 12 | Uimsbf |
| Unused | 16 | Uimsbf |
| Reserved | 2 | Bslbf |
| version_number | 5 | Uimsbf |
| current_next_indicator | 1 | Bslbf |
| section_number | 8 | Uimsbf |
| last_section_number | 8 | Uimsbf |
| Nonce | 40 | Bslbf |
| for (i=0;i<N;i++){ | | |
| lep_id | 16 | Uimsbf |
| region_id | 16 | Uimsbf |
| tot_region_id | 6 | Bslbf |
| Reserved | 2 | Bslbf |
| fips_loop_length | 8 | Uimsbf |
| for (j=0;j<N;j++){ | | |
| state_code | 8 | Uimsbf |
| county_subdivision | 4 | Uimsbf |
| Reserved | 2 | Bslbf |
| county_code | 10 | Uimsbf |
| } | | |
| } | | |
| HMAC-hash | 128 | Uimsbf |
| CRC_32 | 32 | Rpchof |
| } | | |

The meanings of the fields are given below:

table_id: This 8-bit field indicates the specific private table. The value for this table is 0×82 (hex 82).

section_syntax_indicator: This value is ‘1’ according to the standard for being a longer form.

section_length: This is a 12 bit field. It specifies the number of bytes of the section, starting immediately following the section_length field and including the CRC. The section_length preferably does not exceed 4093 so that the entire section preferably has a maximum length of 4096 bytes.

unused: This 16-bit field is unused in this implementation, and should be set to all 1's.

version_number: This 5-bit field indicates the version number of the section. The version_number shall be incremented by 1 when a change is made to the information carried in the section. When it reaches value 31, it wraps around to 0.

current_next_indicator: This value is ‘1’, indicating ‘current’. There is no ‘next’ configuration information according to the DVB/SI standard.

section_number: This 8-bit field gives the number of the section.

last_section_number: This 8-bit field gives the number of the last section.

nonce: This 40-bit field is optional but preferred to prevent the set-top box from being subject to ‘replay’ type malicious denial of service attacks. Typically, it contains the time of creation of this section in Universal Time Co-ordinated (UTC) and Modified Julian (Calendar) Date (MJD) (see DVB/SI standard EN 300 468 annex C). This field is coded as 16 bits giving the 16 LSBs of MJD followed by 24 bits coded as 6 digits in 4-bit Binary Coded Decimal (BCD).

The set-top box preferably only accepts sections that are more recent than the last valid section received. Any maliciously inserted section therefore preferably is required to have a more recent nonce (preventing replays). This data is therefore preferably only accepted with an authenticated hash field—therefore the new section can only come from a source that knows the shared secret.

lep_id: The identifier for the LEP for which the following localization information applies; as noted above, preferably a value of 0 indicates that the information is relevant to all LEP's.

region_id: The RegionId to which the LEP belongs, as used by the OOB configuration table and NIT.

tot_region_id: The tot_region_id is the TOT country_region_id to which this LEP belongs.

fips_loop_length: The length in bytes of the following FIPS code loop. A maximum of some number of FIPS, such as 10 FIPS can be present in the loop (see for example the standard J-STD-042-2202).

state_code: Encoded according to FIPS 6-4. The value of 0 indicates all states.

county_subdivision: Encoded according to the standard J-STD-042-2202.

county_code: Encoded according to FIPS 6-4. The value of 0 indicates the entire state.

HMAC-hash: This field is the HMAC-MD5 hash of all bytes in the section up to, but not including the hash itself.

The hash is preferably calculated as described in RFC 2104 (for example at www.ietf.org/rfc.html), based on repeated use of the MD-5 signature and the use of a shared secret, to generate a 16 byte digest of the section.

The use of a hash is a preferred implementation. The purpose of this hash function is to prevent ‘Denial of Service’ attacks by broadcasting a malicious section.

In conjunction with the nonce field, the hash function may also prevent ‘replay’ attacks.

CRC_{—}32: This is a 32-bit field that contains the CRC value that gives a zero output of the registers in the decoder as defined according to the DOCSIS standard. This might be used by the set-top box—the ‘hash’ field provides a data integrity check, as does the IP checksum field and so the CRC_{—}32 could be somewhat redundant.

reserved: All reserved fields should be set to all ‘1’s.

Table 2 shows the localization configuration table. This table contains the localization information associated with the given LEP. This information optionally and preferably includes the region identifier, node group identifier and FIPS codes for the LEP. The TOT (Time Offset Table) country region id field from the DVB/SI TOT.

TABLE 2
Localization Configuration Table

| Column | Type | Values | Description |
|---|---|---|---|
| LEP_ID | NUMBER(5) | 0 . . . 65535 | A unique identifier |
| | | | for this LEP. |
| REGION_ID | NUMBER(5) | 0 . . . 65535 | The region in which |
| | | | this LEP resides. |
| TOT_REGION_ID | NUMBER(2) | 0 . . . 63 | The TOT country_{—} |
| | | | region_id for this |
| | | | LEP. |
| FIPS_STATE_{—} | NUMBER(2) | 0 . . . 99 | The FIPS code |
| CODE | | | for the State. |
| | | | 0 = all states. |
| FIPS_COUNTY_{—} | NUMBER(3) | 0 . . . 999 | The FIPS code for |
| CODE | | | the County within |
| | | | the State. |
| | | | 0 = all counties |
| FIPS_COUNTY_{—} | NUMBER(1) | 0 . . . 9 | The country sub- |
| SUBDIV | | | division as specified |
| | | | in [12]. |
| | | | 0 = all or an |
| | | | unspecified |
| | | | portion of |
| | | | county |
| UI_DESCR | VARCHAR2 | | Description of |
| | (40) | | this LEP. |
| NOTES | VARCHAR2, | NULL | User Notes |
| | (1000) | | |

According to other preferred embodiments of the present invention, it may optionally be used for VOD (video on demand). VOD enables a consumer to order a particular movie or other content at a convenient time, without being required to wait for a pre-scheduled transmission of the movie. The mapping information and localization of the set-top box according to the present invention enables such services as VOD to be provided, since the VOD server is able to use the mapping information to determine which transport stream should be assigned for VOD to a particular set-top box.

While the invention has been described with respect to a limited number of embodiments, it will be appreciated that many variations, modifications and other applications of the invention may be made.

1. A method for determining cable network topology for a plurality of set-top boxes connected to the cable network, comprising:
using existing information transmitted within the cable network for a non-location purpose to determine an absolute physical location of at least one set-top box within the topology.

2. The method of claim 1, wherein the cable network features two-way transmissions, such that said using said existing information comprises:
listening for an identifier by said at least one set-top box; and
transmitting said identifier in an upstream transmission by said at least one set-top box for identifying said at least one set-top box.

3. The method of claim 2, wherein said listening for said identifier comprises:
receiving mapping information by said at least one set-top box; and
listening to at least one transmission frequency selected according to said mapping information.

4. The method of claim 3, wherein said mapping information includes a LEP (localization entry-point) for analysis of said mapping information.

5. The method of claim 4, wherein said LEP is used as a key for said mapping information.

6. The method of claim 1, wherein said using said existing information comprises transmitting a message on an OOB (out of band) channel.

7. The method of claim 4, further comprising:
transmitting an EMM (entitlement management message) to a portion of the cable network topology according to said LEP.

8. The method of claim 4, further comprising:
transmitting a targeted advertisement to said at least one set-top box according to said at least one LEP.

9. The method of 4, further comprising:
receiving a FIPS code according to said LEP; and
determining an emergency message according to said FIPS code.

10. The method of claim 4, further comprising:
associating a transport stream with a region for a user according to said LEP.

11. The method of claim 1, further comprising:
assigning a LEP (localization entry point) according to a UCID (upstream channel identifier) for at least one set-top box for localizing said at least one set-top box.

12. The method of claim 11, further comprising:
determining at least one location-based or location-sensitive assignment according to said LEP.

13. The method of claim 11, further comprising:
determining at least one location-based or location-sensitive message according to said LEP.

14. The method of claim 11, further comprising:
providing an advertisement to said at least one set-top box according to said LEP.

15. The method of claim 11, wherein said assigning said LEP is performed by a DSG Server, communicating with a DSG Client at said at least one set-top box.

16. A system for determining a relative cable network topology for a plurality of set-top boxes connected to the cable network, the cable network featuring a plurality of transmission channels, wherein each set-top box is capable of listening to at least one transmission channel but not to all transmission channels, the system comprising:
a cable network component for transmitting data to the transmission channels, wherein said transmitted data differs between at least two of the transmission channels;
a map for mapping information concerning a relative location of at least one set-top box within the topology, wherein said map is transmitted to said at least one set-top box and wherein said transmitted data forms a key to said map, such that said at least one set-top box is capable of determining said relative location within the topology according to said map and said key.

17. The system of claim 16, wherein the cable network features two-way transmissions between said cable network component and the plurality of set-top boxes, such that the transmission channels comprising an upstream channel and a downstream channel, said upstream channel featuring an upstream channel identifier, and wherein said at least one set-top box determines a capability of communicating on said upstream channel according to said upstream channel identifier, said at least one set-top box transmitting said upstream channel identifier to said cable network component and said upstream channel identifier forming a portion of said mapping information for said map.

18. The system of claim 17, wherein said transmitted data is transmitted for a purpose other than determining said relative location.

19. The system of claim 17, wherein said transmitted data comprises a LEP (localization entry point).

20. A system for determining a relative cable network topology for a plurality of set-top boxes connected to the cable network, the cable network featuring a plurality of two-way transmission channels, each transmission channel featuring an upstream channel having an upstream identifier and a downstream channel, wherein each set-top box is capable of listening to at least one transmission channel but not to all transmission channels, the system comprising:
a cable network component for receiving a communication from at least one set-top box, wherein said at least one set-top box identifies the upstream identifier of the upstream channel being received by said at least one set-top box and transmits said upstream identifier to said cable network component; and
a map for mapping information concerning a relative location of said at least one set-top box within the topology according to said upstream identifier;
wherein an absolute physical location of each transmission channel within the topology is known.
